(19) United States
(12) Patent Application Publication
(10) Pub. No.: US 2026/0191387 A1
(43) Pub. Date: Jul. 9, 2026

(54) ROBOT CLEANER AND METHOD FOR PREDICTING CLEANING TIME THEREOF

(71) Applicant: SAMSUNG ELECTRONICS CO., LTD., Suwon-si (KR)

(72) Inventors: Boseong JEON, Suwon-si (KR); Jewoong RYU, Suwon-si (KR)

(73) Assignee: SAMSUNG ELECTRONICS CO., LTD., Suwon-si (KR)

(21) Appl. No.: 19/555,002

(22) Filed: Mar. 3, 2026

Related U.S. Application Data
(63) Continuation of application No. PCT/KR2024/012127, filed on Aug. 14, 2024.

(30) Foreign Application Priority Data
Sep. 22, 2023 (KR) 10-2023-0127358

(51) Int. Cl. A47L 11/40

(52) U.S. Cl. CPC A47L 11/4011; A47L 11/4008; A47L 2201/04

(57) ABSTRACT

Provided are a robot cleaner and method of operating same. The robot cleaner includes: at least one sensor; memory storing one or more instructions and an artificial intelligence (AI) model; and one or more processors, wherein the one or more instructions, when executed by the one or more processors individually or collectively, cause the robot cleaner to: acquire information on an area in an indoor space using the at least one sensor while the robot cleaner cleans the area, and input the acquired information on the area into the AI model and acquire an estimated cleaning time for the area from the AI model, and wherein the information on the area includes cell information on a map of the area, environment information on the area, and type information on an obstacle in the area.

### CROSS-REFERENCE TO RELATED APPLICATIONS

This application is a by-pass continuation of International Application No. PCT/KR2024/012127, filed on August 14, 2024, which is based on and claims priority to Korean Patent Application No. 10-2023-0127358, filed in the Korean Intellectual Property Office on September 22, 2023, the disclosures of which are incorporated by reference herein in their entireties.

### BACKGROUND

### 1. Field

The disclosure relates to a robot cleaner for cleaning an indoor space and a method for predicting a cleaning time thereof.

### 2. Description of Related Art

In addition to simple repetitive functions, robots may detect their surroundings in real time using sensors, cameras, and the like, collect information, and autonomously drive. Such robots are currently utilized in various fields, and robot cleaners are widely used in households.

The robot cleaner may drive an indoor space and clean the indoor space by sucking up foreign substances, etc. Generally, the robot cleaner may not predict how much time will be required to clean the indoor space. Accordingly, users may experience inconvenience in daily indoor life, and the cleaning may not be performed more efficiently.

### SUMMARY

According to an aspect of the disclosure, a robot cleaner includes: at least one sensor; memory storing one or more instructions and an artificial intelligence (AI) model; and one or more processors, wherein the one or more instructions, when executed by the one or more processors individually or collectively, cause the robot cleaner to: acquire information on an area in an indoor space using the at least one sensor while the robot cleaner cleans the area, and input the acquired information on the area into the AI model and acquire an estimated cleaning time for the area from the AI model, and wherein the information on the area includes cell information on a map of the area, environment information on the area, and type information on an obstacle in the area.

The cell information on the area may include information on a cell in which an object exists and a cell in which objects do not exist among multiple cells of the map of the area, and the environment information on the area may include information on a position where the robot cleaner collided with the object within the area and information on a position of a cliff within the area.

The memory may stores cleaning history information on the area, and the cleaning history information may include the information on the area acquired using the at least one sensor and information on a cleaning time required to clean the area.

The one or more instructions, when executed by the one or more processors individually or collectively, may further cause the robot cleaner to: acquire the most recent cleaning history information included in the cleaning history information on the area stored in the memory, acquire first information on a portion of the area using the at least one sensor while the robot cleaner cleans the area, identify second information on the portion of the area from the most recent cleaning history information, based on identifying that the first information is different from the second information, acquire third information on remaining portions of the area from the information on the area included in the most recent cleaning history information, and input the first information and the third information into the AI model to acquire the estimated cleaning time for the area.

The robot cleaner may further include: a communication interface, wherein the one or more instructions, when executed by the one or more processors individually or collectively, further cause the robot cleaner to transmit the acquired estimated cleaning time to a mobile device via the communication interface.

The robot cleaner may further include: a communication interface, wherein the one or more instructions, when executed by the one or more processors individually or collectively, further cause the robot cleaner to, based on the acquired estimated cleaning time being greater than the cleaning time required to clean the area included in the most recent cleaning history information, transmit a notification message to a mobile device via the communication interface to request removal of the obstacle within the area.

The one or more instructions, when executed by the one or more processors individually or collectively, may further cause the robot cleaner to: based on the cleaning of the area being completed, train the AI model based on the information on the area acquired using the at least one sensor and the information on the cleaning time required to clean the area.

The one or more instructions, when executed by the one or more processors individually or collectively, may further cause the robot cleaner to store, in the memory, the information on the area acquired using the at least one sensor and the information on the cleaning time required to clean the area.

According to an aspect of the disclosure, a method of predicting a cleaning time of a robot cleaner operating in an area in an indoor space includes: acquiring information on the area using at least one sensor of the robot cleaner while the robot cleaner cleans the area; and inputting the acquired information on the area into an artificial intelligence (AI) model stored in a memory of the robot cleaner and acquiring an estimated cleaning time for the area from the AI model, wherein the information on the area includes cell information on a map of the area, environment information on the area, and type information on an obstacle in the area.

The cell information on the area may include information on a cell in which an object exist and a cell in which objects do not exist among multiple cells of the map of the area, and the environment information on the area may include information on a position where the robot cleaner collided with the object within the area and information on a position of a cliff within the area.

The memory may stores cleaning history information on the area, and the cleaning history information may include the information on the area acquired using the at least one sensor and information on a cleaning time required to clean the area.

The acquiring the information on the area may include: acquiring the most recent cleaning history information included in the cleaning history information on the area stored in the memory; acquiring first information on a portion of the area using the at least one sensor while the robot cleaner cleans the area, identifying second information on the portion of the area from the most recent cleaning history information, and based on identifying that the first information is different from the second information, acquiring third information on remaining portions of the area from the information on the area included in the most recent cleaning history information, and wherein the acquiring the estimated cleaning time may include inputting the first information and the third information into the AI model to acquire the estimated cleaning time for the area.

The method may further include: transmitting the acquired estimated cleaning time to a mobile device.

The method may further include: based on the acquired estimated cleaning time being greater than the cleaning time required to clean the area included in the most recent cleaning history information, transmitting a notification message to a mobile device to request removal of the obstacle within the area.

The method may further include: based on the cleaning of the area being completed, training the AI model based on the information on the area acquired using the at least one sensor and the information on the cleaning time required to clean the area.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a diagram for describing an operation of a robot cleaner according to an embodiment of the present disclosure;

FIG. 2A is a block diagram for describing a configuration of the robot cleaner according to an embodiment of the present disclosure;

FIG. 2B is a block diagram for describing the configuration of the robot cleaner according to an embodiment of the present disclosure;

FIG. 3 is a diagram for describing an example of cleaning history information according to an embodiment of the present disclosure;

FIG. 4 is a flowchart for describing a method for predicting, by a robot cleaner, an estimated cleaning time according to an embodiment of the present disclosure;

FIG. 5 is a diagram for describing an example of acquiring, by a robot cleaner, the most recent cleaning history information according to an embodiment of the present disclosure;

FIGS. 6 and 7 are diagrams for describing an example of a method for acquiring, by a robot cleaner, an estimated cleaning time for an area using an artificial intelligence (AI) model according to an embodiment of the present disclosure;

FIGS. 8 and 9 are diagrams for describing an example of displaying, by a robot cleaner, cleaning-related information of a robot cleaner according to an embodiment of the present disclosure; and

FIG. 10 is a flowchart illustrating a method for predicting a cleaning time of a robot cleaner according to an embodiment of the present disclosure.

### DETAILED DESCRIPTION

One or more embodiments of the present disclosure, and terms used herein, are not intended to limit the technical features described in the present disclosure to specific embodiments, and should be understood to include various changes, equivalents, or substitutes of the embodiments.

Throughout the accompanying drawings, similar or related components will be denoted by similar reference numerals.

A singular form of a noun corresponding to an item may include one or more of the item, unless the relevant context clearly dictates otherwise.

In the present disclosure, each phrase such as “A or B,” “at least one of A and B,” “at least one of A or B,” “A, B, or C,” “at least one of A, B and C,” and “at least one of A, B, or C” may include any one of items listed together in the corresponding one of those phrases, or all possible combinations thereof. For example, “A or B”, “at least one of A and B”, or “at least one of A or B” may indicate all of 1) a case in which at least one A is included, 2) a case in which at least one B is included, or 3) a case in which both of at least one A and at least one B are included.

Terms such as “first,” “second,” “1^{st},” or “2^{nd}” may simply be used to distinguish a component from another component, and do not limit the components in other respects (e.g., importance or order).

When one (e.g., first) component is “coupled,” or “connected,” to another (e.g., second) component with or without the terms “functionally” or “communicatively,” it means that the one component may be connected to another component directly (e.g., in a wired manner), in a wireless manner, or through a third component.

It will be understood that terms “include” or “have” specify the presence of features, numerals, steps, operations, components, parts mentioned in the present document, or a combination thereof, but do not preclude the presence or addition of one or more other features, numerals, steps, operations, components, parts, or a combination thereof.

When a component is said to be “connected,” “coupled,” “supported,” or “in contact” with another component, this includes not only cases where the components are directly connected, coupled, supported, or in contact, but also cases where they are indirectly connected, coupled, supported, or in contact through a third component.

When a component is “on” another component, this includes not only cases where a component is in contact with another component, but also cases where there is another component between the two components.

The term “and/or” includes a combination of a plurality of related described components or any one of the plurality of related described components.

An expression “~an apparatus configured to” may mean that the apparatus “is capable of” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

In exemplary embodiments, a “module” or a “unit” may perform at least one function or operation, and be implemented by hardware or software or be implemented by a combination of hardware and software. In addition, a plurality of “modules” or a plurality of “~ers/~ors” may be integrated in at least one module and be implemented by at least one processor except for a “module” or a “~er/or” that needs to be implemented by specific hardware.

Various elements and regions in the drawings are schematically illustrated. Therefore, the spirit of the disclosure is not limited by relatively sizes or intervals illustrated in the accompanying drawings.

Hereinafter, an embodiment of the disclosure will be described in detail with reference to the accompanying drawings.

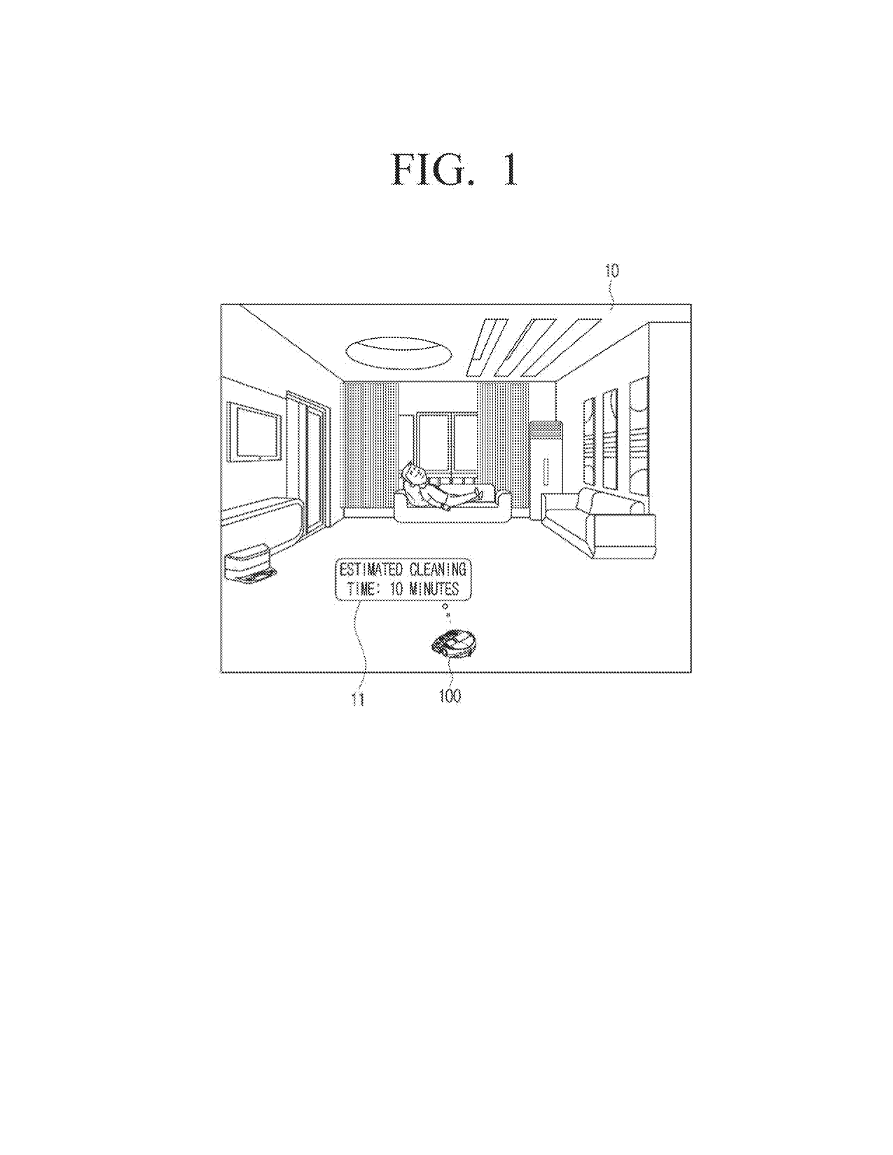

FIG. 1 is a diagram for describing an operation of a robot cleaner according to an embodiment of the present disclosure.

Referring to FIG. 1, a robot cleaner 100 may clean an indoor space 10 in which the robot cleaner 100 is positioned.

The cleaning operation may include the robot cleaner 100 moving around the indoor space to suck up foreign substances such as dust from the floor and to wipe the floor using a mop or the like. The indoor space 10 may include various locations where the robot cleaner 100 may drive, such as a home, office, hotel, factory, store, supermarket, or restaurant.

The robot cleaner 100 may estimate the time (e.g., estimated cleaning time 11 (in FIG. 1)) it takes for the robot cleaner 100 to clean an area within the indoor space. The robot cleaner 100 may acquire an estimated cleaning time for an area using an artificial intelligence (AI) model. For example, the robot cleaner 100 may input cell information on a map of an area, environment information on the area, and type information on obstacles within the area to an AI model to acquire the estimated cleaning time for the area from the AI model.

Furthermore, the robot cleaner 100 may compare the required cleaning time it took the robot cleaner 100 to clean the area in the past with the estimated cleaning time and notify the user of the case where the estimated cleaning time is greater than the required cleaning time.

The user may then organize cluttered items within the area being cleaned by the robot cleaner 100 or change the cleaning order of the area being cleaned by the robot cleaner 100. Accordingly, according to the present disclosure, the robot cleaner 100 may clean an indoor space more efficiently.

Furthermore, the cell information on the map of the area, the environment information on the area, and the type information on the obstacles within the area may be used when estimating the cleaning time.

The cell information on the map of the area may include information on cells in which objects exist and information on cells in which objects do not exist among multiple cells divided on the map of the area. Objects may include walls and obstacles within the indoor space. Obstacles may include various objects within the indoor space, such as furniture, home appliances, people, and pets.

Furthermore, the environment information on the area may include 3D environment information on the area. For example, the environment information on the area may include information on a position where the robot cleaner 100 collided with objects within the area and information on a position of a cliff within the area.

In this way, according to the present disclosure, the estimated cleaning time for the area of the robot cleaner 100 may be predicted based on various pieces of information that may affect a driving pattern of the robot cleaner 100.

For example, the driving pattern of the robot cleaner 100 may vary depending on a geometric shape (e.g., the geometric shape indicated by lines connecting the multiple cells) of multiple cells in which objects exist in the area, the type of objects present in the area, the position where the robot cleaner 100 collides with the objects in the area, the position of the cliff in the area, etc. Depending on this driving pattern, the time it takes for the robot cleaner 100 to move around the area for cleaning may vary. Therefore, as in the present disclosure, when the estimated cleaning time is predicted using the cell information on the map of the area, the environment information on the area, and the type information on the obstacles in the area, the estimated cleaning time of the robot cleaner 100 for the area may be predicted more accurately.

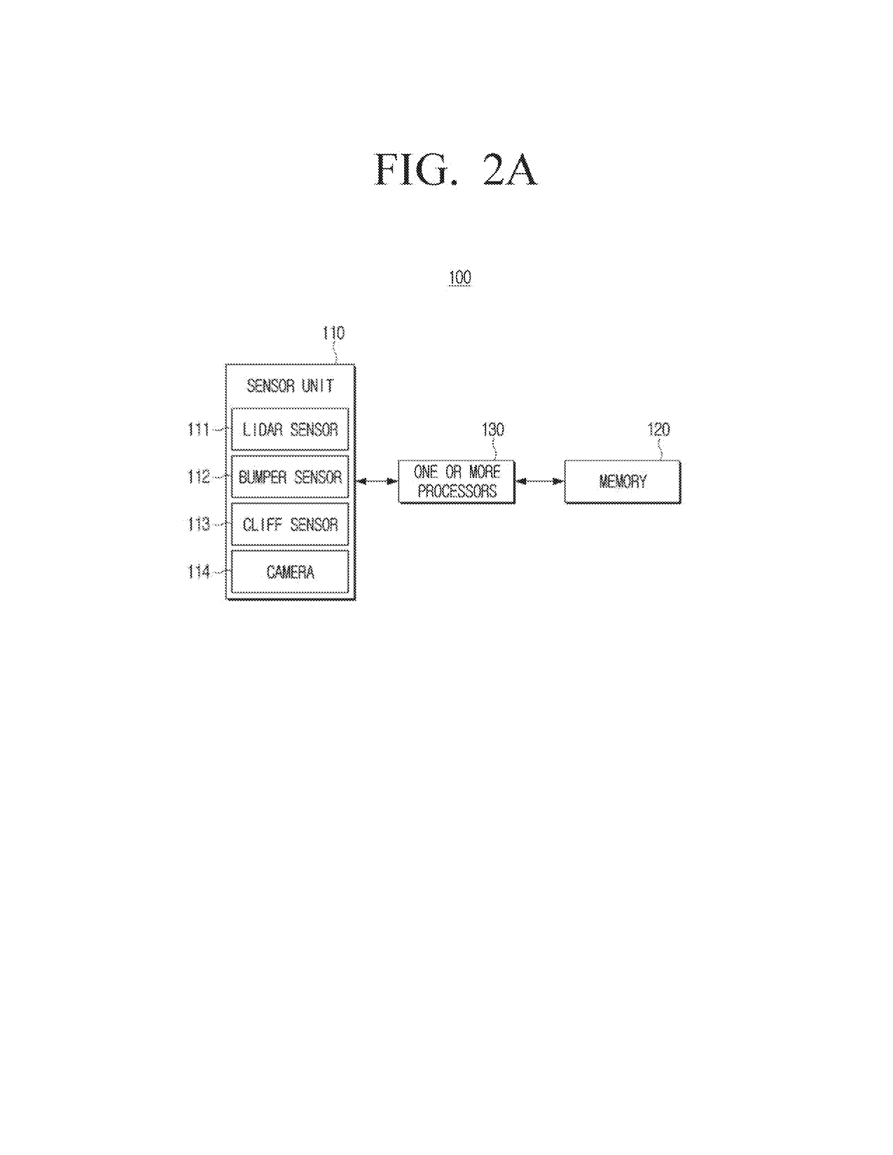

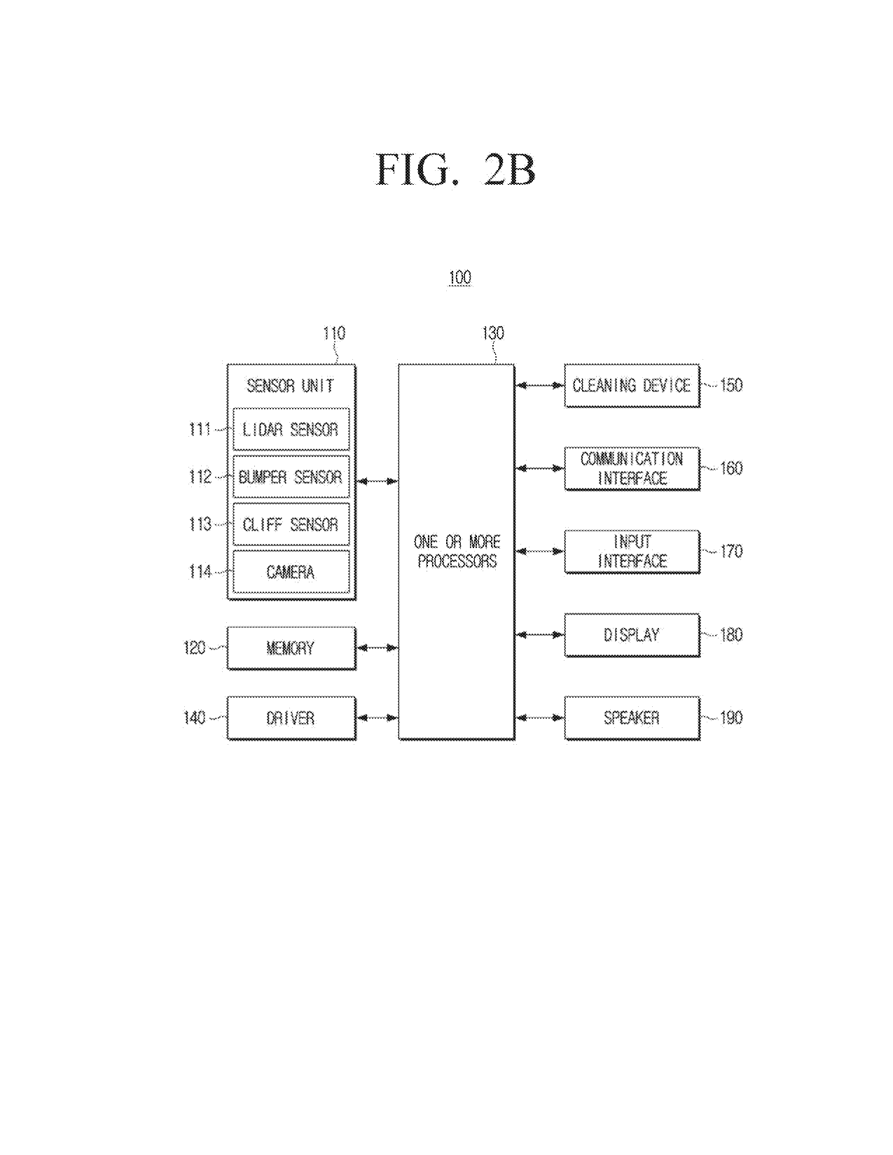

FIG. 2A is a block diagram for describing a configuration of the robot cleaner according to an embodiment of the present disclosure.

Referring to FIG. 2A, the robot cleaner 100 includes a sensor unit 110, a memory 120, and one or more processors 130.

The sensor unit 110 may detect structures or obstacles in an indoor space. Furthermore, the information acquired by the sensor unit 110 may be used to generate the map of the indoor space.

The sensor unit 110 may include one or more sensors including a light detection and ranging (LiDAR) sensor 111, a bumper sensor 112, a cliff sensor 113, and a camera 114. The disclosure is not limited to these examples.

The LiDAR sensor 111 outputs a laser beam in a 360° direction. When the laser beam reflected from the objects is received, the LiDAR sensor analyzes the time difference taken for the laser to be reflected from the objects and return, and the received laser beam signal intensity etc., thereby acquiring the geometry information on the indoor space. The geometry information may include the positions, distances, and directions of the objects within the indoor space. The LiDAR sensor 111 may provide the acquired geometry information to one or more processors 130.

The bumper sensor 112 may detect external impacts. The bumper sensor 112 may be provided on at least one of the front, left, and right sides of the main body of the robot cleaner 100. The bumper sensor 112 detects the amount of impact generated when the main body collides with an external object (e.g., a threshold) and may detect the collision between the robot cleaner 100 and the objects based on the detected amount of impact. Furthermore, the bumper sensor 112 may provide the information on the detected collision of the robot cleaner 100 to one or more processors 130.

The cliff sensor 113 may detect a cliff existing on the movement path of the robot cleaner 100. The cliff sensor 113 may include one or more light-emitting elements and one or more light-receiving elements. The cliff sensor 113 may measure the time taken for light emitted from the light-emitting element toward the floor to be received by the light-receiving element, measure the distance between the cliff sensor 113 and the floor based on the measured time, and detect the cliff using the measured distance. When there is a sharply lowered step or a cliff on the movement path of the robot cleaner 100, the time taken for light to be received by the light-receiving element rapidly increases, or the light is not received by the light-receiving element. Accordingly, the cliff sensor 113 may detect the cliff using the change in the received time. In addition, the cliff sensor 113 may provide the information on the detected cliff to one or more processors 130.

The camera 114 (or camera module) may obtain images by capturing the surrounding area of the robot cleaner 100. The camera may capture images of the front of the robot cleaner 100, the ceiling, floor, etc., of the indoor space, and acquire images of various objects surrounding the robot cleaner 100, such as ceilings, walls, entrances, and obstacles.

For example, the robot cleaner 100 may include a front camera for capturing the images of the front of the robot cleaner 100, an upper camera for capturing the ceiling, and a lower camera for capturing the floor. However, this example is not limited thereto, and the number, disposition position, capturing range, etc., of cameras may vary.

The camera 114 may include one or more optical lenses, an image sensor including multiple pixels that receive light passing through the optical lenses, an image signal processor that constitutes an image based on signals output from the image sensor, etc. One or more processors 130 may capture the indoor space where the robot cleaner 100 is positioned using the camera 114 to acquire the images of at least one object within the indoor space.

The memory 120 may store data necessary for the operation of the robot cleaner 100 according to one or more embodiments of the present disclosure.

For example, the memory 120 may store one or more AI models.

The AI model may include a neural network model trained to predict the estimated cleaning time of the robot cleaner 100 for the area based on the information on the area. The information on the area may include the cell information on the map of the area, the environment information on the area, and the type information on the obstacles within the area. The AI model may receive the information on the area, and output the estimated cleaning time required to be required for the robot cleaner 100 to clean the area based on the information on the area.

For example, the AI model may include a neural network model composed of trained model parameters, which applies information about each of a plurality of areas acquired from the respective areas as input data, and applies the time actually required for the robot cleaner 100 to clean each area as the output ground-truth value.

Furthermore, the AI model may include a neural network model trained to recognize the type of objects from images. The AI model may output a label value for the type of objects inferred from the image input to the AI model and a confidence value for the label value. The confidence value may include a probability value indicating that the type of objects inferred from the image may be inferred as a specific type.

For example, the AI model may include a neural network model composed of model parameters trained by applying a plurality of images as input data and label values of objects included in the images as the output ground-truth value.

The neural network model according to the present disclosure refers to an AI model that includes a neural network and may be trained through deep learning. The neural network may include, for example, at least one of a convolutional neural network (CNN), a recurrent neural network (RNN), a restricted Boltzmann machine (RBM), a deep belief network (DBN), a bidirectional recurrent deep neural network (BRDNN), generative adversarial networks (GANs), and deep Q-Networks. However, the neural network model is not limited to the examples described above.

As described above, the AI model may be implemented in the form of an on-device embedded in the robot cleaner 100. However, the AI model is not limited thereto, and may be stored on a server connected to the robot cleaner 100. When the AI model is stored on the server, the robot cleaner 100 may transmit the information or images on the area to the server and receive the estimated cleaning time or the type information of objects from the server.

The memory 120 may store one or more instructions. One or more processors 130 may individually or collectively execute one or more instructions stored in the memory 120 to perform the operations of the robot cleaner 100 according to embodiments of the present disclosure. The memory 120 may store programs, applications, and data for driving the robot cleaner 100.

The one or more processors 130 control the overall operation of the robot cleaner 100. Specifically, the one or more processors 130 are connected to components of the robot cleaner 100 and may control the overall operation of the robot cleaner 100. For example, the one or more processors 130 may be connected to the sensor unit 110 and the memory 120 to control the robot cleaner 100. The one or more processors 130 may be composed of one or a plurality of processors.

One or more processors 130 may execute one or more instructions stored in the memory 120 to perform the operations of the robot cleaner 100 according to one or more embodiments of the present disclosure.

The one or more processors 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. One or more processors 130 may control one or any combination of other components of the robot cleaner 100 and may perform operations related to communication or data processing. The one or more processors 130 may execute one or more programs or instructions stored in the memory 120. For example, one or more processors 130 may perform a method according to an embodiment of the present disclosure by executing one or more instructions stored in the memory 120.

When the method according to an embodiment of the present disclosure includes multiple operations, the multiple operations may be performed by one processor or by multiple processors. For example, when a first operation, a second operation, and a third operation are performed by the method according to an embodiment, the first operation, the second operation, and the third operation may all be performed by the first processor, or the first operation and the second operation may be performed by the first processor (e.g., a general-purpose processor) and the third operation may be performed by the second processor (e.g., an AI-dedicated processor).

The one or more processors 130 may be implemented as a single core processor including one core, or may be implemented as one or more multicore processors including multiple cores (e.g., a homogeneous multicore or a heterogeneous multicore). When one or more processors 130 are implemented as a multi-core processor, each of the plurality of cores included in the multi-core processor may include an internal processor memory such as cache memory and on-chip memory, and a common cache shared by the plurality of cores may be included in the multi-core processor. In addition, each of the plurality of cores (or some of the plurality of cores) included in the multi-core processor may independently read and execute a program command for implementing the method according to an embodiment of the present disclosure, or all (or some) of the plurality of cores may be linked to read and execute the program command for implementing the method according to an embodiment of the present disclosure.

When the method according to an embodiment of the present disclosure includes a plurality of operations, the plurality of operations may be performed by one of the plurality of cores included in the multi-core processor, or may be performed by the plurality of cores. For example, when the first operation, the second operation, and the third operation are performed by the method according to one or more embodiments, the first operation, the second operation, and the third operation may all be performed by a first core included in the multi-core processor, or the first operation and the second operation may be performed by the first core included in the multi-core processor, and the third operation may be performed by a second core included in the multi-core processor.

In one or more embodiments of the present disclosure, a processor may mean a system on chip (SoC) in which one or more processors and other electronic components are integrated, a single core processor, a multi-core processor, or a core included in the single core processor or the multi-core processor. Here, the core may be implemented as the CPU, the GPU, the APU, the MIC, the DSP, the NPU, the hardware accelerator, the machine learning accelerator, etc., but the present disclosure is not limited thereto.

FIG. 2B is a block diagram for describing the configuration of the robot cleaner according to an embodiment of the present disclosure.

Referring to FIG. 2B, the robot cleaner 100 may include a sensor unit 110, memory 120, one or more processors 130, a driver 140, a cleaning device 150, a communication interface 160, an input interface 170, a display 180, and a speaker 190. However, such a configuration is an example, and it goes without saying that a new configuration may be added or some configuration may be omitted in addition to such a configuration in carrying out the present disclosure. A detailed description for components overlapped with components illustrated in FIG. 2A among components illustrated in FIG. 2B will be omitted.

The sensor unit 110 may include an obstacle detection sensor for detecting obstacles present around the robot cleaner 100. For example, the obstacle detection sensor may include an ultrasonic sensor, an infrared sensor, a radio frequency (RF) sensor, etc. The obstacle detection sensor may detect obstacles present in front, behind, to the side, or along the movement path of the robot cleaner 100. The one or more processors 130 may control the driving of the robot cleaner 100 using the information on obstacles detected using the obstacle detection sensor.

The sensor unit 110 may include a driving detection sensor for detecting the driving of the robot cleaner 100.

For example, the driving detection sensor may include a gyro sensor, a wheel encoder, an acceleration sensor, etc. The gyro sensor may detect the rotation direction and rotation angle of the robot cleaner 100. The wheel encoder may detect the rotation speed of one or more wheels of the robot cleaner 100. The acceleration sensor may detect the change in the speed of the robot cleaner 100. The one or more processors 130 may control the driving of the robot cleaner 100 using the information acquired through the sensor unit 110.

The driver 140 may move the robot cleaner 100. For example, the driver 140 may include at least one wheel, at least one motor for rotating the wheel, a brake for stopping the rotating wheel, etc. The one or more processors 130 control the driver 140 to perform various driving operations, such as movement, stopping, speed control, direction change, and angular velocity change, of the robot cleaner 100.

The cleaning device 150 may suck up foreign substances from the floor. For example, the cleaning device 150 may include a brush assembly for sweeping and sucking up dust from the floor, a vacuum cleaning module for sucking up dust, and a mop cleaning module for mopping. The sucked foreign substances may be stored in a dust bin provided in the robot cleaner 100. The one or more processors 130 may control the cleaning device 150 to suck up foreign substances present on the floor while the robot cleaner 100 is stopping or moving. Accordingly, the robot cleaner 100 may perform cleaning of an indoor space.

The communication interface 160 may communicate with an external device via a network. The external device may include servers, home appliances, mobile devices (e.g., smartphones, tablet PCs, wearable devices, etc.), etc. The communication interface 160 may include a wireless communication module or a wired communication module. The communication module may be implemented with at least one hardware chip.

The network may include a wide area network (WAN) such as the Internet, a local area network (LAN) formed around an access point (AP), and a short-range wireless network that does not utilize the access point (AP). The short-range wireless network may include, but is not limited to, Bluetooth™ (IEEE 802.15.1), Zigbee (IEEE 802.15.4), Wi-Fi Direct, near field communication (NFC), Z-Wave, etc.

According to an example, the communication interface 160 may communicate with the external device via the access point (AP). For example, the access point (AP) may connect the local area network (LAN) to which the robot cleaner 100 is connected to the wide area network (WAN) to which the server is connected. The robot cleaner 100 may be connected to the server via the WAN. The access point (AP) may communicate with the robot cleaner 100 using wireless communication such as Wi-Fi (Wi-Fi™, IEEE 802.11), Bluetooth, or Zigbee, and may connect to the WAN using wired communication. In addition, the communication interface 160 may communicate with other external devices via the server. For example, the communication interface 160 may communicate with home appliances, mobile devices, etc., via the server.

According to an example, the robot cleaner 100 may be directly connected to the external device without going through the access point (AP). For example, the communication interface 160 may communicate with the external device via a long-range wireless network or a short-range wireless network. The robot cleaner 100 may be connected to home appliances, mobile devices, etc., via the short-range wireless network (e.g., Wi-Fi Direct). Furthermore, the robot cleaner 100 may be connected to the external devices via the wide area network (WAN) using the long-range wireless network (e.g., a cellular communication module).

The input interface 170 includes circuitry. The input interface 170 may receive user input and transmit the user input to one or more processors 130. For example, the input interface 170 may receive various user inputs for setting or selecting various functions supported by the robot cleaner 100.

The input interface 170 may include various types of input devices.

According to an example, the input interface 170 may include a physical button. The physical button may include a function key or a dial button. The physical button may also be implemented as one or more keys.

According to an example, the input interface 170 may receive user input using a touch type. For example, the input interface 170 may be implemented as a touch screen capable of performing the functions of the display 180.

According to an example, the input interface 170 may receive user voice using a microphone. The one or more processors 130 may perform functions corresponding to the user input using voice recognition. For example, the one or more processors 130 may convert user voice into text data using a speech-to-text (STT) function, acquire control command data based on the text data, and perform functions corresponding to the user voice based on the control command data. According to the embodiment, the STT function may be performed by an external server.

The display 180 may display various screens. One or more processors 130 may display various notifications, messages, information, etc., related to the operation of the robot cleaner 100 on the display 180.

The display 180 may be implemented as a display including a self-light emitting element or a display including a non-light emitting element and a backlight. For example, the display 180 may be implemented in various forms, such as a liquid crystal display (LCD), an organic light emitting diodes (OLED) display, a light emitting diodes (LED) display, a micro LED display, a mini LED display, and a quantum dot light-emitting diodes (QLED) display.

The speaker 190 may output audio signals. The one or more processors 130 may output warning sounds, notification messages, response messages corresponding to user input, etc., related to the operation of the robot cleaner 100, through the speaker 190.

Hereinafter, for convenience of description, the one or more processors 130 will be referred to as the processor 130.

The processor 130 may use the information acquired using the sensor unit 110 to generate the map of the indoor space where the robot cleaner 100 is positioned. The map may be generated during the initial exploration of the indoor space.

For example, the processor 130 may use the LiDAR sensor 111 to explore the indoor space, acquire topographic information on the indoor space, and generate the map of the indoor space using the topographic information.

The map may include a grid map. The grid map is a map that divides the indoor space into cells of a certain size. For example, the grid map may be the map that divides the indoor space into multiple cells of a preset size and indicates the presence or absence of objects in each cell. The multiple cells may be divided into cells without objects (e.g., cells where the robot cleaner 100 can drive) (free space) and cells with objects (occupied space). Lines connecting cells occupied by objects may represent boundaries (e.g., walls, obstacles, etc.) of the space. The processor 130 may generate the map of the indoor space using information acquired using the obstacle detection sensor.

The map may include a plurality of areas. The area may be distinguished from other areas by walls or other obstacles (e.g., door frames, windows, fences, stairs, etc.). The area may correspond to a sub-space (e.g., room) included in the indoor space.

The processor 130 may identify the position of the robot cleaner 100 on the map using simultaneous localization and mapping (SLAM) technology.

For example, the processor 130 may acquire the topographic information of the indoor space using the LiDAR sensor 111, compare the acquired topographic information with pre-stored topographic information, or compare the acquired topographic information to identify the position of the robot cleaner 100 on the map.

In addition, the processor 130 may acquire images using the camera 114 while the robot cleaner 100 is driving in the indoor space, map features for each position of the area acquired from the image to each position of the map, and store the mapped features in the memory 120. In addition, the processor 130 may acquire the images using the camera 114, and compare the features for the area acquired from the image with the features stored in the memory 120 to identify the position of the robot cleaner 100 on the map in order to identify the current position of the robot cleaner 100.

The processor 130 may acquire the information using the sensor unit 110 while the robot cleaner 100 is driving in the indoor space, and detect obstacles around the robot cleaner 100 using the acquired information. Furthermore, when the processor 130 identifies an obstacle, it may determine a driving pattern, such as straight or turning, based on the properties of the obstacle and control the driver 140 to move the robot cleaner 100 according to the determined driving pattern.

Accordingly, the robot cleaner 100 may move while avoiding obstacles within the indoor space and clean the indoor space by sucking up foreign substances on the floor.

The robot cleaner 100 may sequentially clean a plurality of areas on the map. For example, the processor 130 may determine a cleaning order for the plurality of areas so that cleaning starts from the nearest area based on the charging station or the position where the robot cleaner 100 starts cleaning, and control the robot cleaner 100 to clean the plurality of areas according to the cleaning order. Furthermore, the processor 130 may transmit the cleaning order of the robot cleaner 100 to the server via the communication interface 160. The server may store the information on the cleaning order received from the robot cleaner 100 and display a UI screen including the cleaning information on the robot cleaner 100 on the mobile device according to the cleaning order.

The cleaning order may be determined or changed based on the user input.

For example, a user may connect to the server by executing an application installed on the user’s mobile device, generate a user account, and register the robot cleaner 100 by communicating with the server based on the logged-in user account. The server may register the robot cleaner 100 to the user account by registering identification information (e.g., serial number or MAC address) of the robot cleaner 100 in the user account.

Then, the user may control the robot cleaner 100 using the application installed on the mobile device. For example, when a user logs into a user account using the application installed on the mobile device, a user interface (UI) screen related to the robot cleaner 100 registered to the user account may be displayed on the mobile device. The UI screen may receive the user input for controlling the robot cleaner 100, and display various pieces of information related to the operation of the robot cleaner 100. When a user inputs the user input for setting the cleaning order of the robot cleaner 100 on the UI screen, the control command for causing the robot cleaner 100 to clean the plurality of areas according to the set cleaning order may be transmitted to the robot cleaner 100 via the server. The processor 130 may receive the control command from the server via the communication interface 160, and control the robot cleaner 100 to clean the plurality of areas according to the cleaning order based on the control command.

The processor 130 may acquire the information on the area using the sensor unit 110 while the robot cleaner 100 cleans the area.

The information on the area may include the cell information on the map of the area, the environment information on the area, and the type information on the obstacles within the area.

The cell information on the map of the area may include information on cells in which objects exist and information on cells in which objects do not exist among the multiple cells of the map of the area. For example, the processor 130 may acquire the topographic information on the area using the LiDAR sensor 111 while the robot cleaner 100 cleans the area. Furthermore, the processor 130 may acquire the grid map of the area using the topographic information, thereby acquiring the cell information on the area. The grid map includes multiple cells, and the multiple cells may include one or more cells in which objects are detected and one or more cells in which objects are not detected based on the search results by the LiDAR sensor 111.

The environment information of the area may include the information on the position where the robot cleaner 100 collides with objects within the area. For example, the processor 130 may detect the collision between the robot cleaner 100 and the objects using the bumper sensor 112 while the robot cleaner 100 cleans the area, and identify the position where the robot cleaner 100 collides with the objects on the map of the area.

The environment information of the area may include the information on the position of the cliff within the area. For example, the processor 130 may detect the cliff using the cliff sensor 113 while the robot cleaner 100 cleans the area, and identify the position of the cliff on the map of the area.

Furthermore, the processor 130 may identify the type of obstacles within the area. For example, the processor 130 may capture the images of the area using the camera 114 while the robot cleaner 100 cleans the area, thereby acquiring the images. The processor 130 inputs the acquired images to the AI model to recognize the type of obstacles (e.g., wires, pee pads, clothes, carpets, etc.) present in the area. For example, the processor 130 may acquire the information on the type of objects based on the label value and confidence value output by the AI model. Furthermore, the processor 130 may label the type of objects at the object’s position on the map of the area, thereby acquiring the type information on the obstacles within the area.

The processor 130 may store the cleaning history information on the area in the memory 120.

The cleaning history information on the area may include the information on the area and the required cleaning time for the area.

For example, the processor 130 may acquire the required cleaning time for the area by measuring the time from when the robot cleaner 100 starts cleaning the area to when the robot cleaner 100 completes cleaning. Furthermore, when the robot cleaner 100 completes cleaning an area, the processor 130 may store, in the memory 120, the information on the area acquired using the sensor unit 110 while the robot cleaner 100 cleans the area, as well as the information on the cleaning time required for the robot cleaner 100 to clean the area.

The processor 130 may acquire the cleaning history information each time the robot cleaner 100 cleans an area and store the acquired cleaning history information in the memory 120. The memory 120 may store the cleaning history information on each area. Furthermore, the processor 130 may transmit the cleaning history information to the server via the communication interface 160. The server may store the information on the cleaning history information received from the robot cleaner 100 and display the required cleaning time on the mobile device.

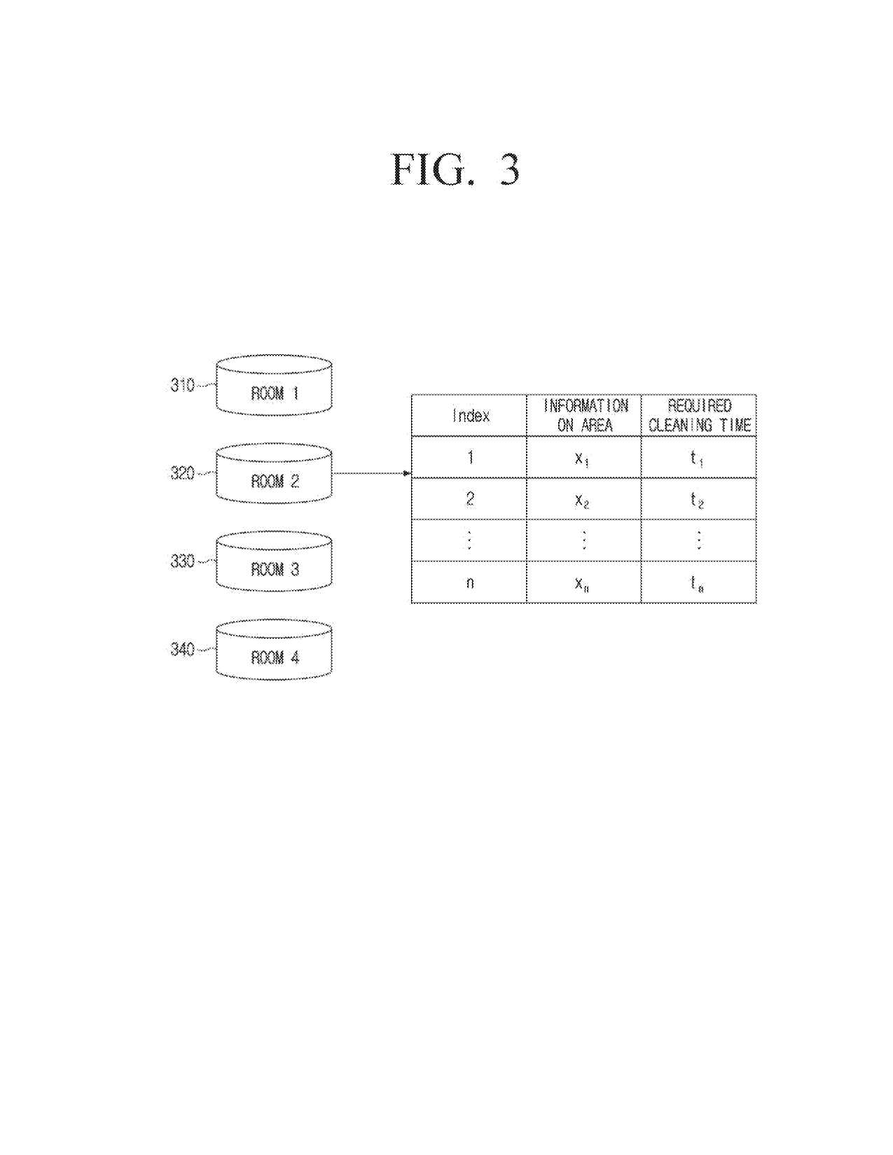

For example, it is assumed that there are four rooms in an indoor space. Referring to FIG. 3, the processor 130 may store cleaning history information 310, 320, 330, and 340 of the robot cleaner 100 for four rooms in the memory 120. The memory 120 may include the cleaning history information 310 for Room 1, the cleaning history information 320 for Room 2, the cleaning history information 330 for Room 3, and the cleaning history information 340 for Room 4.

The cleaning history information may include the information on the area acquired using the sensor unit 110 when the robot cleaner 100 cleans the area, and the information on the cleaning time required to clean the area. For example, the cleaning history information 320 for Room 2 may include information on areas x₁, x₂, ..., xₙ and the required cleaning time t₁, t₂, ..., tₙ. n is the number of times that the robot cleaner 100 cleans Room 2.

While the robot cleaner 100 cleans an area within an indoor space, the processor 130 acquires the information on the area using the sensor unit 110 and inputs the acquired information to the AI model to acquire the estimated cleaning time for the area from the AI model.

Hereinafter, a method for predicting the estimated cleaning time of the robot cleaner 100 will be described in more detail.

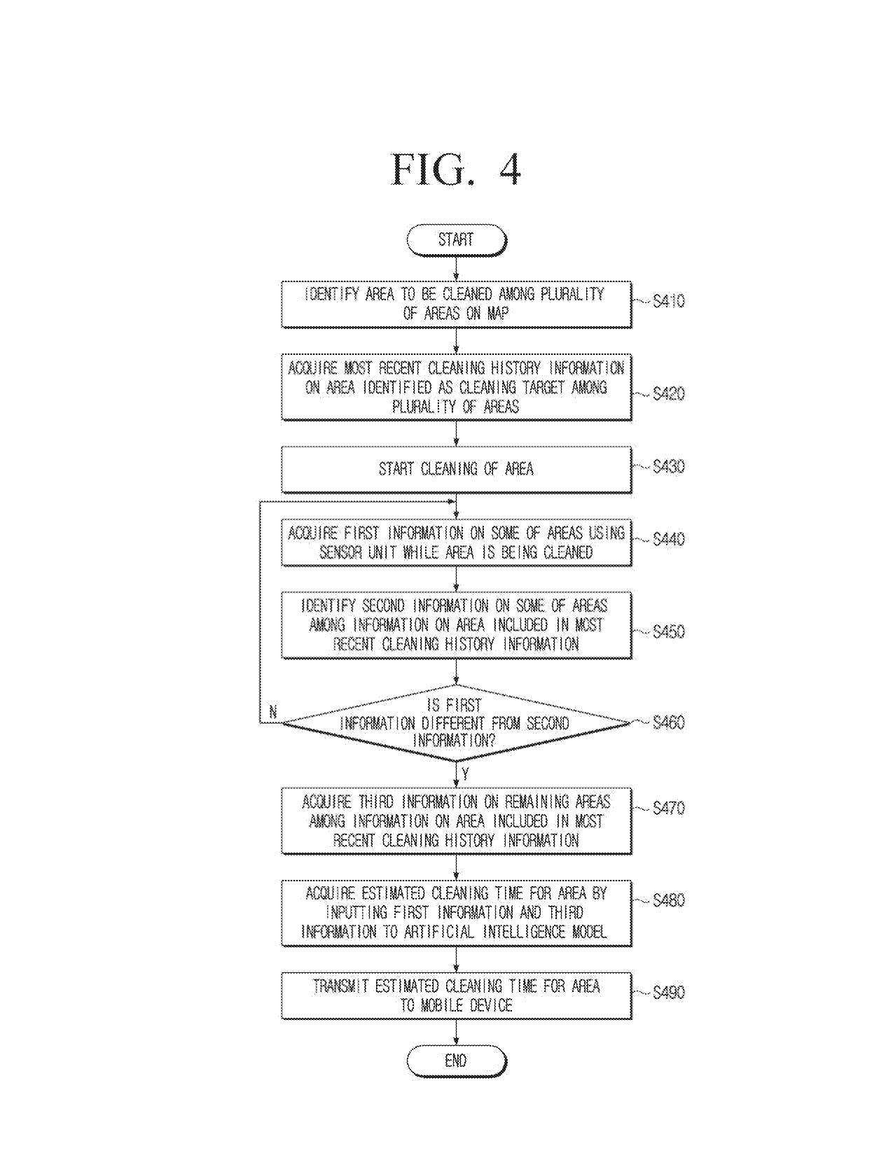

FIG. 4 is a flowchart for describing a method for predicting, by a robot cleaner, an estimated cleaning time according to an embodiment of the present disclosure.

The processor 130 may identify the area where the robot cleaner 100 will perform cleaning among the plurality of areas on the map (S410). For example, the processor 130 may identify the area where the robot cleaner 100 will perform cleaning among the plurality of areas on the map based on the cleaning order.

The processor 130 may acquire the most recent cleaning history information on an area identified as a cleaning target among the plurality of areas (S420). The processor 130 may acquire the most recent cleaning history information on the area stored in the memory 120.

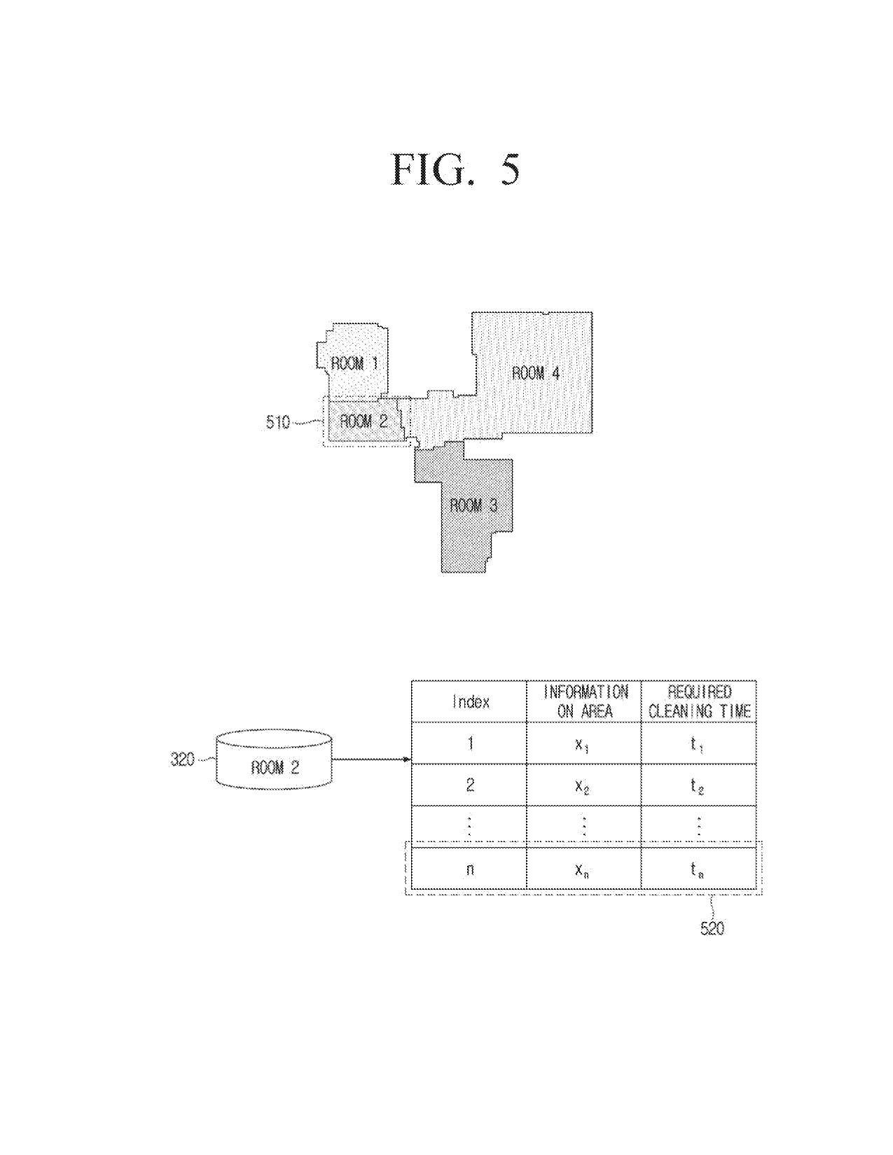

For example, referring to FIG. 5, it is assumed that Room 2 510 is the area to be cleaned by the robot cleaner 100. The processor 130 may acquire, from the cleaning history information 320 on Room 2 stored in the memory 120, information xₙ520 on the area most recently acquired by the robot cleaner 100 while cleaning Room 2, and the required cleaning time tₙ520 for the robot cleaner 100 to most recently clean Room 2.

The processor 130 may control the robot cleaner 100 to clean the area identified as the cleaning target (S430). For example, the processor 130 may control the driver 140 to move within the area after the robot cleaner 100 moves to the area, and may control the cleaning device 150 to suck up foreign substances present on the floor.

While the robot cleaner 100 cleans an area, the processor 130 may use the sensor unit 110 to acquire first information on a portion of the area (S440).

For example, when the robot cleaner 100 moves within the area to clean the area, the processor 130 may explore a portion of the area within the range detectable by the sensor unit 110 based on the current position of the robot cleaner 100 within the entire area, and acquire information on a portion of the area based on the search results.

The first information on a portion of the area may include the cell information on the map, the environment information on a portion of the area, and the type information on the obstacles within a portion of the area.

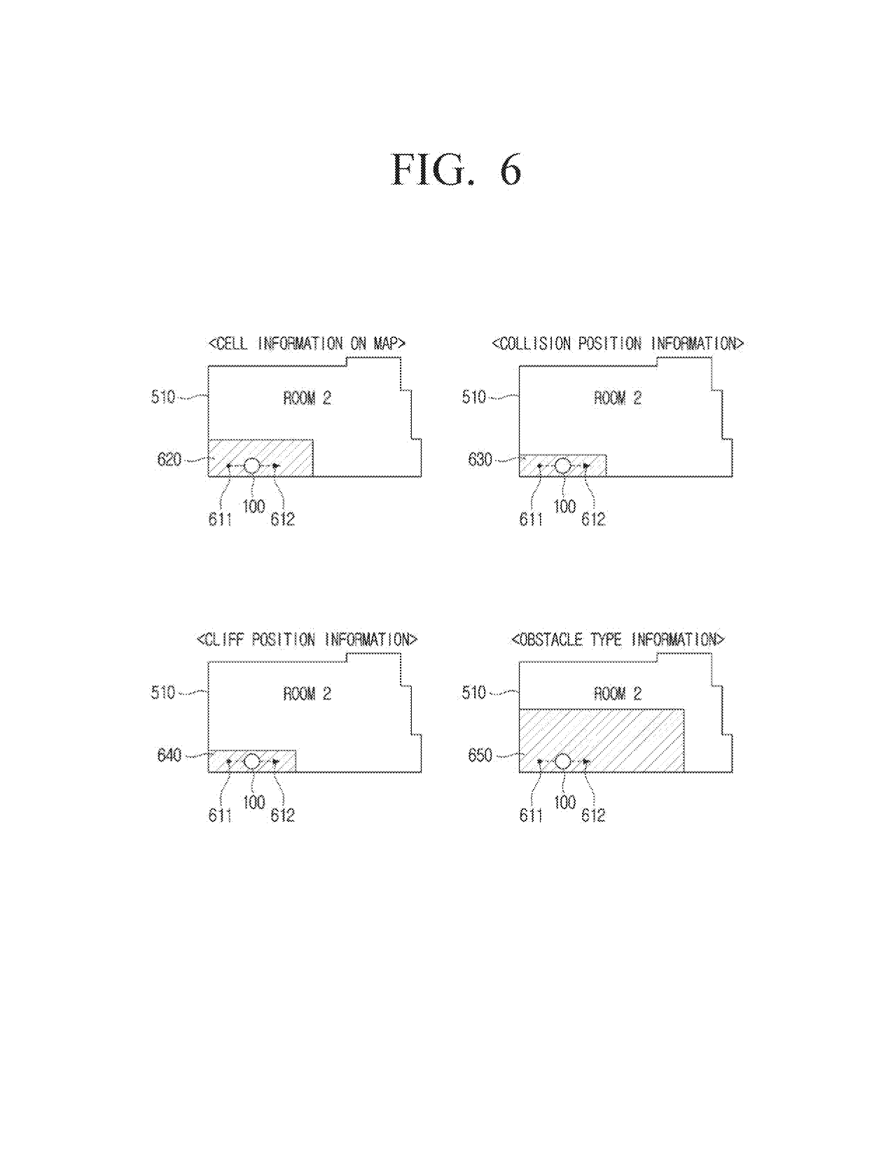

For example, as illustrated in FIG. 6, the processor 130 may acquire topographic information using the LiDAR sensor 111 while the robot cleaner 100 moves from a first position 611 to a second position 612 in Room 2 510. In addition, the processor 130 may acquire a grid map of a portion of Room 2 510 using the topographic information, and acquire cell information 620 on a map for a portion of the area.

In addition, the processor 130 may detect whether the robot cleaner 100 collides with objects using the bumper sensor 112 while the robot cleaner 100 moves from a first position 611 to a second position 612 in room 2 510. When the processor 130 identifies that a collision has occurred between the robot cleaner 100 and an object, the processor 130 may acquire information 630 on the position where the robot cleaner 100 collides with the object within a portion of room 2 510.

In addition, the processor 130 may detect the presence of the cliff using the cliff sensor 113 while the robot cleaner 100 moves from the first position 611 to the second position 612 in room 2 510. When the processor 130 identifies that the cliff has been detected, the processor 130 may acquire information 640 on the position of the cliff within a portion of room 2 510.

In addition, the processor 130 may acquire an image using the camera 114 while the robot cleaner 100 moves from the first position 611 to the second position 612 in room 2510. The processor 130 may recognize the type of obstacles from the image and acquire type information 650 on obstacles within a portion of room 2 510.

The processor 130 may identify second information on a portion of the areas among the information on the areas included in the most recent cleaning history information.

For example, the processor 130 may identify a portion of the areas explored by the sensor unit 110. According to an embodiment, the processor 130 may identify a portion of the areas explored by the sensor unit 110 within each area based on the movement path of the robot cleaner 100 within the area, the detection range of the sensor, etc. Furthermore, the processor 130 may acquire second information on a portion of the areas identified among the most recently acquired information on the area. The second information on a portion of the area may include the cell information on the map, the environment information on a portion of the area, and the type information on the obstacles within a portion of the area.

The processor 130 may identify whether there is a difference between the first information and the second information on some of the areas (S460).

For example, the processor 130 may identify that there is a difference between the first information and the second information when a new object that was not most recently detected by the LiDAR sensor 111 in some areas is now detected by the LiDAR sensor 111 in some areas, or when an object that was most recently detected by the LiDAR sensor 111 in some areas is now not detected by the LiDAR sensor 111 in some areas.

Furthermore, the processor 130 may identify that there is a difference between the first information and the second information when a collision that was most recently not detected by the bumper sensor 112 in some areas is now detected by the bumper sensor 112 in some areas, or when a collision that was most recently detected by the bumper sensor 112 in some areas is now not detected by the bumper sensor 112 in some areas.

Additionally, the processor 130 may identify that there is a difference between the first information and the second information when the cliff that was not most recently detected by the cliff sensor 113 in some areas is now detected by the cliff sensor 113 in some areas, or when the cliff that was most recently detected by the cliff sensor 113 in some areas is now not detected by the cliff sensor 113 in some areas.

Additionally, the processor 130 may identify that there is a difference between the first information and the second information when an object not most recently recognized in an image by the camera 114 in some areas is now recognized by the camera 114 in some areas, or when an object most recently recognized in some areas by the camera 114 is not now recognized by the camera 114 in some areas.

In this way, the processor 130 may identify that there is a difference between the first information and the second information when the information explored by at least one sensor while the robot cleaner 100 cleans an area differs from the most recently explored information.

When the processor 130 identifies that there is a difference between the first information and the second information (S460-Y), the processor 130 may acquire third information on the remaining areas from among the information on the areas included in the most recent cleaning history information (S470).

For example, the processor 130 may identify the remaining areas not explored by the sensor unit 110 among the areas. According to an example, the processor 130 may identify the remaining areas not explored by the sensors within each area. Furthermore, the processor 130 may acquire the third information on the remaining areas from among the most recently acquired information on the areas. The third information on the remaining areas may include the cell information on the map of the remaining areas, the environment information on the remaining areas, and the type information on the obstacles within the remaining areas.

The processor 130 may input the first and third information to the AI model to acquire the estimated cleaning time for the area (S480).

According to an example, the processor 130 may acquire, as the input data for the AI model, the information on some areas explored by the sensor unit 110 while the robot cleaner 100 is currently cleaning the area, and the information on the remaining areas explored by the sensor unit 110 when the robot cleaner 100 most recently cleans the area. In addition, the processor 130 may input the input data to the AI model to acquire the estimated cleaning time for the area of the robot cleaner 100.

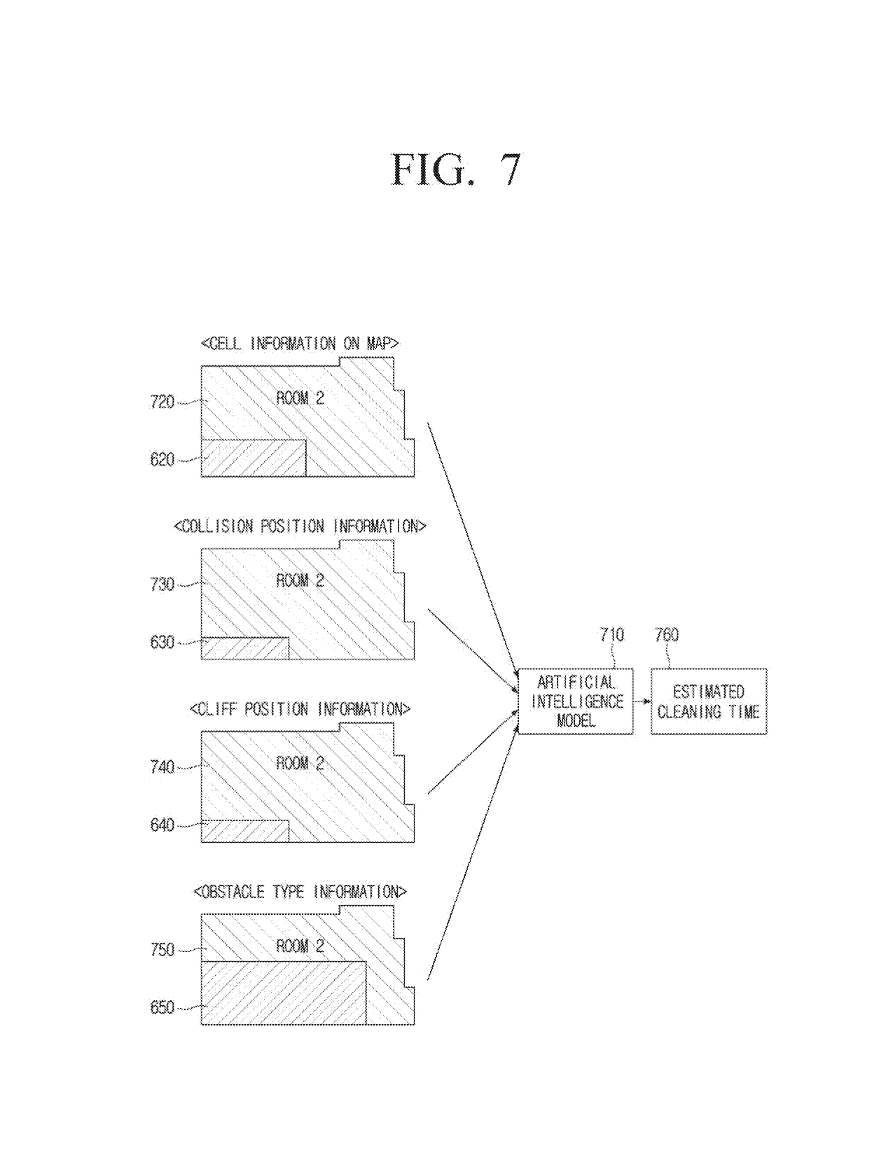

For example, as illustrated in FIG. 7, the processor 130 may acquire, as input data for the AI model 710, the cell information 620 on map for some areas acquired using the LiDAR sensor 111 while the robot cleaner 100 cleans Room 2, and cell information 720 on map for the remaining areas of Room 2 most recently acquired using the LiDAR sensor 111.

In addition, the processor 130 may acquire, as input data for the AI model 710, collision position information 630 of the robot cleaner 100 within a portion of the area acquired using the bumper sensor 112 while the robot cleaner 100 cleans Room 2, and collision position information 730 of the robot cleaner 100 within the remaining areas most recently acquired using the bumper sensor 112.

In addition, the processor 130 may acquire, as the input data for the AI model 710, information 640 on the position of the cliff within a portion of the area acquired using the cliff sensor 113 while the robot cleaner 100 cleans Room 2, and information 740 on the position of the cliff within the remaining areas most recently acquired using the bumper sensor 112.

Additionally, the processor 130 may acquire, as the input data for the AI model 710, type information 650 on obstacles within a portion of the area acquired using the camera 114 while the robot cleaner 100 cleans Room 2, and type information 750 on obstacles within the remaining areas most recently acquired using the camera 114.

The processor 130 may then input the input data into the AI model 710 to acquire the estimated cleaning time 760 of the robot cleaner 100 for Room 2.

The processor 130 may transmit the estimated cleaning time for the area to a mobile device via the communication interface 160 (S490). For example, the processor 130 may transmit the estimated cleaning time to the server via the communication interface 160. Upon receiving the estimated cleaning time from the robot cleaner 100, the server may transmit the estimated cleaning time to the mobile device registered to the user account. The mobile device may display the estimated cleaning time.

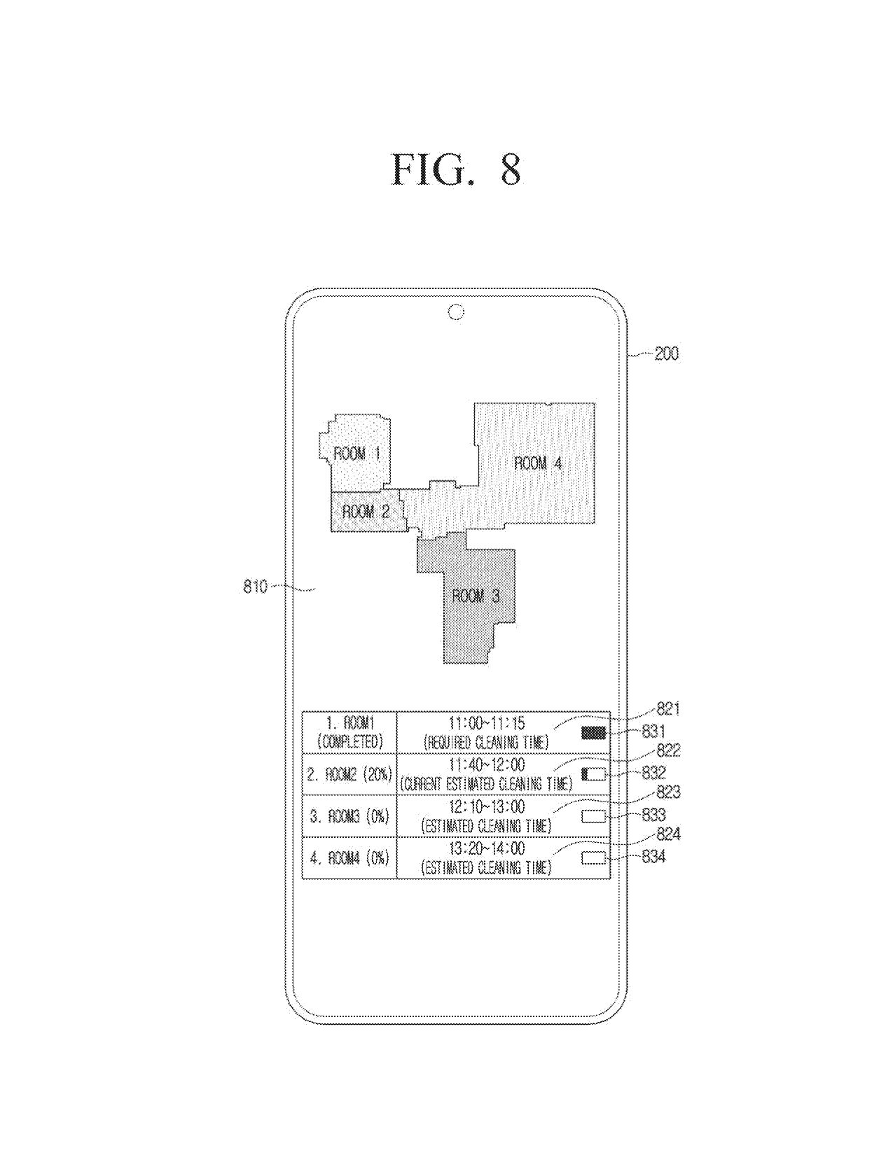

For example, referring to FIG. 8, it is assumed that the cleaning order of the robot cleaner 100 is Room 1 -> Room 2 -> Room 3 -> Room 4.

The mobile device 200 may display a UI screen 810 including cleaning information of the robot cleaner 100 for each room.

The cleaning information may include a required cleaning time 821 of the room that the robot cleaner 100 has currently completed cleaning, a estimated cleaning time 822 of the room that the robot cleaner 100 is currently cleaning, and estimated cleaning times 823 and 824 of rooms that have not yet been cleaned.

For example, the required cleaning time 821 may be the time required for the robot cleaner 100 to clean the room after it has completed cleaning. The estimated cleaning time 822 may be the estimated cleaning time for the robot cleaner 100 to currently clean the room and may be the estimated cleaning time predicted by an AI model. The estimated cleaning time 823 and 824 may be the time required for the robot cleaner 100 to most recently clean the room.

The cleaning information may include GUIs 831, 832, 833, and 834 indicating the cleaning progress. For example, the processor 130 may calculate the cleaning progress based on the number of cells the robot cleaner 100 has moved relative to the total number of cells in the grid map of the area, and transmit the calculated cleaning progress to the mobile device via the server.

The user may change the cleaning order of the robot cleaner 100 using the UI screen. For example, it is assumed that there is still work to be done in Room 3 when the robot cleaner 100 starts cleaning Room 3 after completing cleaning Room 2. The user may input the user input on the UI screen 810 to change the cleaning order of Room 3 and Room 4 so that the robot cleaner 100 cleans Room 2 and then Room 4. The server may transmit a control command corresponding to the user input to the robot cleaner 100. The processor 130 may change the cleaning order of the robot cleaner 100 based on the control command received from the server. Accordingly, the robot cleaner 100 may clean Room 4 after completing cleaning Room 2.

In addition, when the estimated cleaning time for the area is greater than the required cleaning time included in the most recent cleaning history information, the processor 130 may transmit a notification message to the mobile device via the communication interface 160. For example, the processor 130 may transmit the control command to the mobile device via the server to display the notification message.

The notification message may include the notification message requesting the removal of the obstacles within an area.

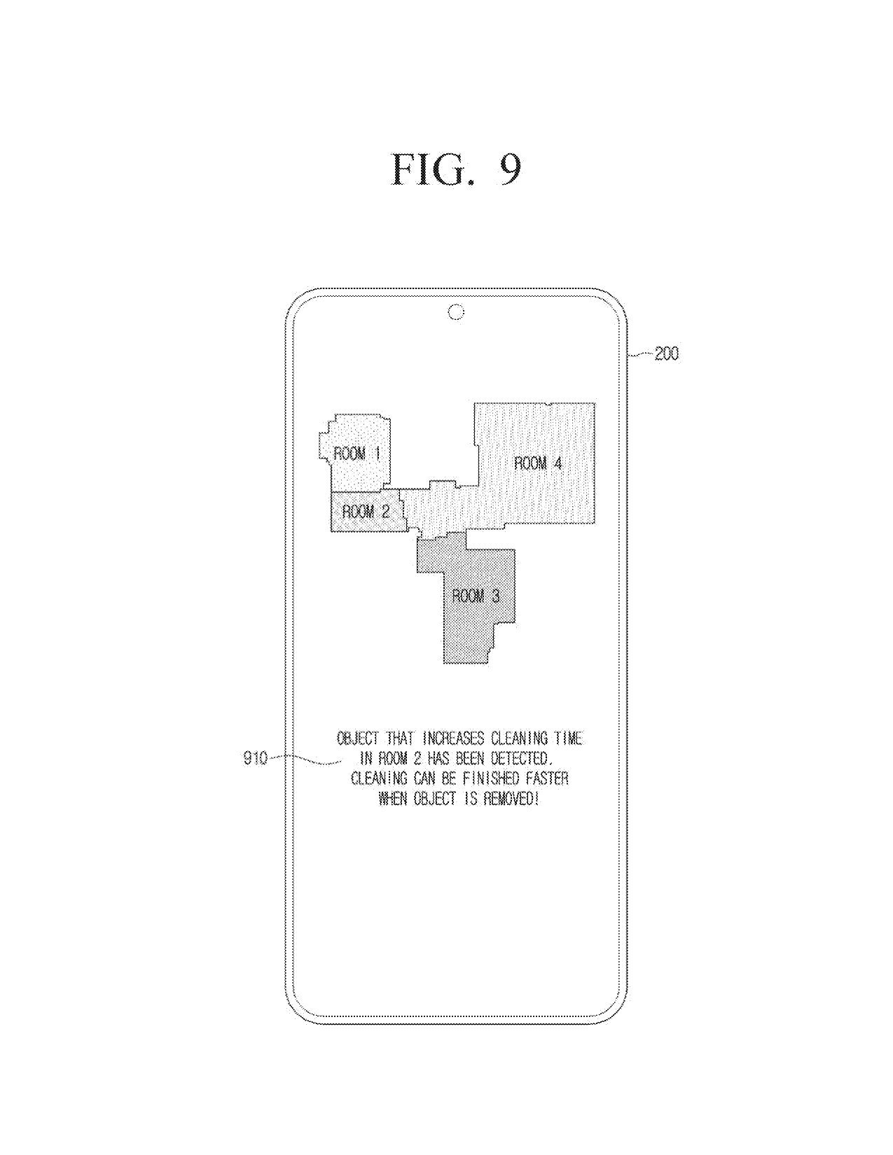

For example, as illustrated in FIG. 9, the mobile device 200 may display a notification message 910 such as, “an object that increases the cleaning time of Room 2 has been detected. The cleaning may be completed more quickly when the object is removed.” The user may organize cluttered items in room 2 where the robot cleaner 100 cleans according to the notification message. Furthermore, when the user anticipates that cleaning Room 2 will take a long time, the user may change the cleaning order of Room 2 to that of other rooms. Accordingly, according to the present disclosure, the robot cleaner 100 may clean an indoor space more efficiently.

When the cleaning of the area is completed, the processor 130 may store the information on the area and the required cleaning time for the area, acquired using the sensor unit 110 while the robot cleaner 100 cleans the area, in the memory 120. Furthermore, when the cleaning of the area is completed, the processor 130 may train the AI model based on the information on the area and the required cleaning time for the area, acquired using the sensor unit 110 while the robot cleaner 100 cleans the area.

In the example described above, the processor 130 may measure the time from when the robot cleaner 100 starts cleaning Room 2 to when the robot cleaner 100 completes cleaning, thereby acquiring the required cleaning time tₙ₊₁ for Room 2. Furthermore, when the robot cleaner 100 completes the cleaning of Room 2, the processor 130 may store, in the memory 120, the information xₙ₊₁ for Room 2 and the required cleaning time tₙ₊₁ for Room 2, acquired using the sensor unit 110 while the robot cleaner 100 cleans Room 2, thereby updating the cleaning history information for Room 2. Furthermore, the processor 130 may train the AI model by applying the information xₙ₊₁ for Room 2 as the input data for the AI model and the required cleaning time tn+1 for Room 2 as the output ground-truth value of the AI model.

In addition, when the cleaning of the area is completed, the processor 130 may transmit, to the server via the communication interface 160, the information on the area and the required cleaning time for the area, acquired using the sensor unit 110 while the robot cleaner 100 cleans the area. The server may train the AI model stored in the server using the information on the area and the required cleaning time for the area received from the robot cleaner 100. The trained AI model may be used to update the AI model stored in the robot cleaner 100.

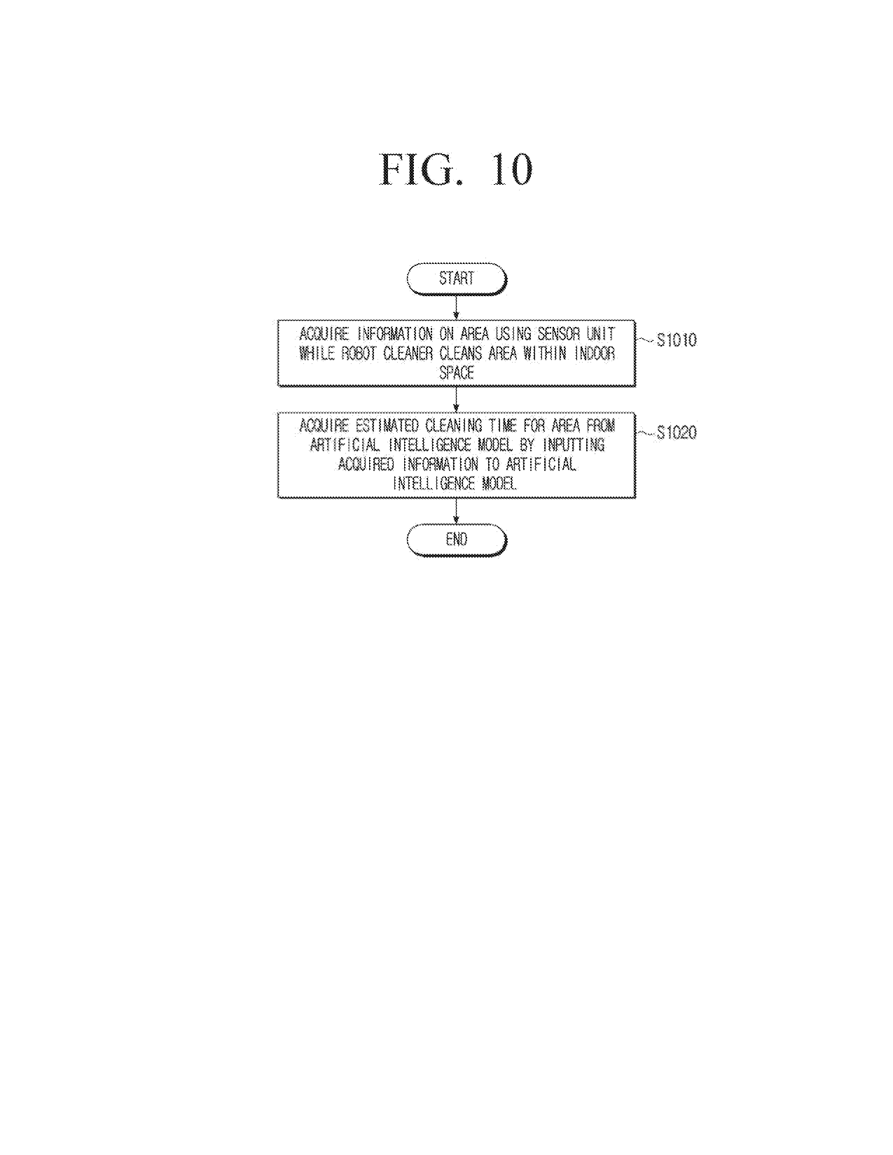

FIG. 10 is a flowchart illustrating a method for predicting a cleaning time of a robot cleaner according to an embodiment of the present disclosure.

The robot cleaner includes a memory storing the AI model that outputs the estimated cleaning time for the robot cleaner for the area based on information on the area.

While the robot cleaner cleans an area within an indoor space, the robot cleaner acquires the information on the area using its sensor unit (S1010). The information on the area includes the cell information on the map of the area, the environment information on the area, and the type information on the obstacles within the area. The cell information on the area may include information on cells including objects and cells without objects among multiple cells in the map of the area. Furthermore, the environment information on the area may include the information on the position where the robot cleaner collides with objects within the area and information on the position of the cliff within the area.

The acquired information is input to the AI model, and the estimated cleaning time for the area is acquired from the AI model (S1020).

The memory may store the cleaning history information on the area. The cleaning history information may include information on the area acquired using the sensor unit when the robot cleaner cleans the area, as well as the information on the cleaning time required to clean the area.

In addition, in operation S1010, the most recent cleaning history information on the area stored in the memory may be acquired, the first information on some areas using the sensor unit may be acquired while the robot cleaner cleans the area, the second information on some areas is identified from the information on the areas included in the most recent cleaning history information, and when the first information is identified as different from the second information, the third information on the remaining areas may be acquired from the information on the area included in the most recent cleaning history information. In operation S1020, the first information and the third information may be input to the AI model to acquire the estimated cleaning time for the area.

In addition, the method for predicting a cleaning time according to an embodiment of the present disclosure may transmit the acquired estimated cleaning time to the mobile device.

In addition, the method for predicting a cleaning time according to an embodiment of the present disclosure may transmit the notification message to the mobile device requesting the removal of obstacles within the area when the acquired estimated cleaning time is greater than the required cleaning time included in the most recent cleaning history information.

In addition, the method for predicting a cleaning time according to an embodiment of the present disclosure may train the AI model based on the information on the area acquired using the sensor unit while the robot cleaner cleans the area and the required cleaning time for the area, when the cleaning of the area is completed.

In addition, the method for predicting a cleaning time according to an embodiment of the present disclosure may store, in the memory, the information on the area acquired using the sensor unit while the robot cleaner cleans the area and the required cleaning time for the area, when the cleaning of the area is completed.

According to an embodiment of the disclosure, one or more embodiments described above may be implemented by software including commands stored in a machine-readable storage medium (for example, a computer-readable storage medium). A machine is a device capable of calling a stored command from a storage medium and operating according to the called instruction, and may include the electronic device of the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

In addition, according to an embodiment of the disclosure, the above-described methods according to the diverse embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore^{TM}). In case of the online distribution, at least a portion of the computer program product may be at least temporarily stored in a storage medium such as a memory of a server of a manufacturer, a server of an application store, or a relay server or be temporarily generated.

In addition, according to an embodiment of the disclosure, one or more embodiments described above may be implemented in a computer or a computer-readable recording medium using software, hardware, or a combination of software and hardware. In some cases, embodiments described in the present disclosure may be implemented by the processor itself. According to a software implementation, embodiments such as procedures and functions described in the disclosure may be implemented by separate software. Each software may perform one or more functions and operations described in the disclosure.

Computer instructions for performing processing operations of the machines according to the diverse embodiment of the disclosure described above may be stored in a non-transitory computer-readable medium. The computer instructions stored in the non-transitory computer-readable medium allow a specific machine to perform the processing operations in the machine according to the diverse embodiments described above when they are executed by a processor of the specific machine. The non-transitory computer-readable medium is not a medium that stores data for a while, such as a register, a cache, a memory, or the like, but means a medium that semi-permanently stores data and is readable by the apparatus. A specific example of the non-transitory computer-readable medium may include a compact disk (CD), a digital versatile disk (DVD), a hard disk, a Blu-ray disk, a universal serial bus (USB), a memory card, a read only memory (ROM), or the like.

In addition, each of components (for example, modules or programs) according to one or more embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Although one or more embodiments of the disclosure have been illustrated and described hereinabove, the disclosure is not limited to the abovementioned specific embodiments, but may be variously modified by those skilled in the art to which the disclosure pertains without departing from the gist of the disclosure as disclosed in the accompanying claims. These modifications should also be understood to fall within the scope and spirit of the disclosure.

What is claimed is:

1. A robot cleaner comprising:
at least one sensor;
memory storing one or more instructions and an artificial intelligence (AI) model; and
one or more processors,
wherein the one or more instructions, when executed by the one or more processors individually or collectively, cause the robot cleaner to:
acquire information on an area in an indoor space using the at least one sensor while the robot cleaner cleans the area, and
input the acquired information on the area into the AI model and acquire an estimated cleaning time for the area from the AI model, and
wherein the information on the area comprises cell information on a map of the area, environment information on the area, and type information on an obstacle in the area.

2. The robot cleaner of claim 1, wherein the cell information on the area comprises information on a cell in which an object exists and a cell in which objects do not exist among multiple cells of the map of the area, and
wherein the environment information on the area comprises information on a position where the robot cleaner collided with the object within the area and information on a position of a cliff within the area.

3. The robot cleaner of claim 1, wherein the memory stores cleaning history information on the area, and
wherein the cleaning history information comprises the information on the area acquired using the at least one sensor and information on a cleaning time required to clean the area.

4. The robot cleaner of claim 3, wherein the one or more instructions, when executed by the one or more processors individually or collectively, further cause the robot cleaner to:
acquire the most recent cleaning history information included in the cleaning history information on the area stored in the memory,
acquire first information on a portion of the area using the at least one sensor while the robot cleaner cleans the area,
identify second information on the portion of the area from the most recent cleaning history information,
based on identifying that the first information is different from the second information, acquire third information on remaining portions of the area from the information on the area included in the most recent cleaning history information, and
input the first information and the third information into the AI model to acquire the estimated cleaning time for the area.

5. The robot cleaner of claim 4, further comprising:
a communication interface,
wherein the one or more instructions, when executed by the one or more processors individually or collectively, further cause the robot cleaner to transmit the acquired estimated cleaning time to a mobile device via the communication interface.

6. The robot cleaner of claim 4, further comprising:
a communication interface,
wherein the one or more instructions, when executed by the one or more processors individually or collectively, further cause the robot cleaner to, based on the acquired estimated cleaning time being greater than the cleaning time required to clean the area included in the most recent cleaning history information, transmit a notification message to a mobile device via the communication interface to request removal of the obstacle within the area.

7. The robot cleaner of claim 3, wherein the one or more instructions, when executed by the one or more processors individually or collectively, further cause the robot cleaner to:
based on the cleaning of the area being completed, train the AI model based on the information on the area acquired using the at least one sensor and the information on the cleaning time required to clean the area.

8. The robot cleaner of claim 3, wherein the one or more instructions, when executed by the one or more processors individually or collectively, further cause the robot cleaner to store, in the memory, the information on the area acquired using the at least one sensor and the information on the cleaning time required to clean the area.

9. A method of predicting a cleaning time of a robot cleaner operating in an area in an indoor space, the method comprising:
acquiring information on the area using at least one sensor of the robot cleaner while the robot cleaner cleans the area; and
inputting the acquired information on the area into an artificial intelligence (AI) model stored in a memory of the robot cleaner and acquiring an estimated cleaning time for the area from the AI model,
wherein the information on the area comprises cell information on a map of the area, environment information on the area, and type information on an obstacle in the area.

10. The method of claim 9, wherein the cell information on the area comprises information on a cell in which an object exist and a cell in which objects do not exist among multiple cells of the map of the area, and
wherein the environment information on the area comprises information on a position where the robot cleaner collided with the object within the area and information on a position of a cliff within the area.

11. The method of claim 9, wherein the memory stores cleaning history information on the area, and
wherein the cleaning history information comprises the information on the area acquired using the at least one sensor and information on a cleaning time required to clean the area.

12. The method of claim 11, wherein the acquiring the information on the area comprises:
acquiring the most recent cleaning history information included in the cleaning history information on the area stored in the memory;
acquiring first information on a portion of the area using the at least one sensor while the robot cleaner cleans the area,
identifying second information on the portion of the area from the most recent cleaning history information, and
based on identifying that the first information is different from the second information, acquiring third information on remaining portions of the area from the information on the area included in the most recent cleaning history information, and
wherein the acquiring the estimated cleaning time comprises inputting the first information and the third information into the AI model to acquire the estimated cleaning time for the area.

13. The method of claim 12, further comprising:
transmitting the acquired estimated cleaning time to a mobile device.

14. The method of claim 12, further comprising:
based on the acquired estimated cleaning time being greater than the cleaning time required to clean the area included in the most recent cleaning history information, transmitting a notification message to a mobile device to request removal of the obstacle within the area.

15. The method of claim 11, further comprising:
based on the cleaning of the area being completed, training the AI model based on the information on the area acquired using the at least one sensor and the information on the cleaning time required to clean the area.

16. The method of claim 11, further comprising:
storing, in the memory, the information on the area acquired using the at least one sensor and the information on the cleaning time required to clean the area.

17. A non-transitory computer readable recording medium storing computer instructions that cause a robot cleaner to perform an operation when executed by a processor of the robot cleaner, wherein the operation comprises:
acquiring information on the area using at least one sensor of the robot cleaner while the robot cleaner cleans the area; and
inputting the acquired information on the area into an artificial intelligence (AI) model stored in a memory of the robot cleaner and acquiring an estimated cleaning time for the area from the AI model,
wherein the information on the area comprises cell information on a map of the area, environment information on the area, and type information on an obstacle in the area.

18. The non-transitory computer readable recording medium of claim 17, wherein the cell information on the area comprises information on a cell in which an object exist and a cell in which objects do not exist among multiple cells of the map of the area, and
wherein the environment information on the area comprises information on a position where the robot cleaner collided with the object within the area and information on a position of a cliff within the area.

19. The non-transitory computer readable recording medium of claim 17, wherein the memory stores cleaning history information on the area, and
wherein the cleaning history information comprises the information on the area acquired using the at least one sensor and information on a cleaning time required to clean the area.

20. The non-transitory computer readable recording medium of claim 19, wherein the acquiring the information on the area comprises:
acquiring the most recent cleaning history information included in the cleaning history information on the area stored in the memory;
acquiring first information on a portion of the area using the at least one sensor while the robot cleaner cleans the area,
identifying second information on the portion of the area from the most recent cleaning history information, and
based on identifying that the first information is different from the second information, acquiring third information on remaining portions of the area from the information on the area included in the most recent cleaning history information, and
wherein the acquiring the estimated cleaning time comprises inputting the first information and the third information into the AI model to acquire the estimated cleaning time for the area.
